(19) United States
(12) Patent Application Publication
(10) Pub. No.: US 2006/0242676 A1
(43) Pub. Date: Oct. 26, 2006

(54) Live streaming broadcast method, live streaming broadcast device, live streaming broadcast system, program, recording medium, broadcast method, and broadcast device

(75) Inventor: Atsushi Hoshino, Ibaraki (JP)

Correspondence Address: MICHAUD-DUFFY GROUP LLP, 306 INDUSTRIAL PARK ROAD, SUITE 206, MIDDLETOWN, CT, 06457, US

(73) Assignee: Institute of Tsukuba Liaision Co., Ltd., Ibaraki (JP)

(21) Appl. No.: 10/566,689

(22) PCT Filed: Jul. 28, 2004
(86) PCT No.: PCT/JP04/10720

§ 371 Date: Jan. 31, 2006

(30) Foreign Application Priority Data
Jul. 31, 2003 (JP) 2003-284061

(51) Int. Cl. H04N 7/173

(52) U.S. Cl. 725/105

(57) ABSTRACT

To provide a live streaming broadcasting method of high quality and low cost. The present invention also resides in a live streaming broadcasting apparatus and system, a program and a recording medium. A live streaming broadcasting method in accordance with the present invention includes the steps of carrying out live broadcasting through a network. The method also includes inputting a plurality of camera image data, synthesized image data obtained by synthesizing process for synthesizing a plurality of camera image data during the inputting are output to a network for auditing by clients.

### TECHNICAL FIELD

The present invention relates to a live streaming broadcasting method, a live streaming broadcasting apparatus, a live streaming broadcasting system, programs, a recording medium, a broadcasting method and broadcasting apparatus.

### BACKGROUND ART

There has been carried out conventionally an internet live broadcast for broadcasting images (pictures) and voices to clients through a network such as the internet, that is, a live streamingbroadcast.

In order for clients to listen to live streamingbroadcasts, a browser may be started by an auditory terminal to get access to a home page of a broadcasting presenter. Broadcasting content data is received by the auditory terminal. The data received by the auditory terminal is converted into a streaming file by the decoding process in a streaming player (including a streaming decoder) incorporated in the terminal for auditory in advance so that an image from the broadcast content is displayed on a display screen of the auditory terminal, and the voice is output from a speaker. Thereby, the clients are able to listen to the broadcasting contents.

It is to be noted that the auditory terminal can be, for example, a general purpose PC (Personal Computer). Further, the streaming player is a streaming player incorporated into a general purpose browser, or an exclusive use streaming player, both of which are constructed within the auditory terminal for auditory by installing a program (software) on the auditory terminal.

On the other hand, in order to allow the broadcaster to initiate the live streamingbroadcast, a broadcasting program is started by a broadcasting terminal, while voice data is input into the broadcasting terminal from, for example, camera image data andmicrophone. This data is subjected to encode-processing in accordance with the broadcasting program to allow the data to be output to the network.

It is noted that the broadcasting terminal is, for example, a general purpose PC, and, the broadcasting program is a general purpose program (software) including streaming encoder functionality.

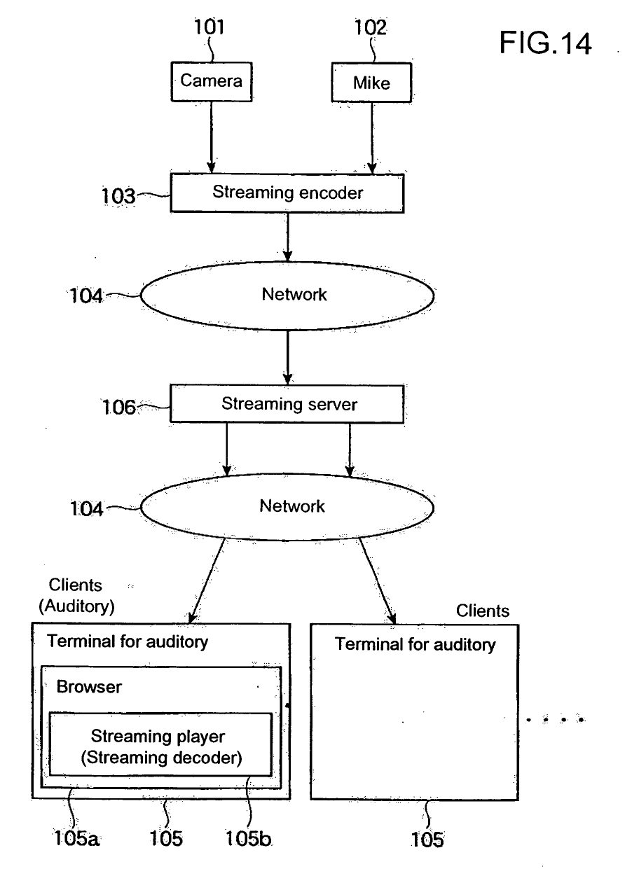

FIG. 14 is a flow chart showing the live streaming broadcasting as described above.

As shown in FIG. 14, on the broadcaster side, image data (animations) from a camera 101 and voice data from a microphone 102 are encode-processed and converted into a streaming file, which is continuously output to a network 104. Broadcasting data to be output are input into a streaming server 106.

Further, in an auditory terminal 105 on the client side, a browser 105a is started so that broadcasting data from the broadcaster is continuously received through a network 104 from a streaming server 106, the received broadcasting data is decode-processed by a streaming player (streaming decoder) 105b within the auditory terminal 105 to continuously carry out image display and voice output. Thereby, on the listener side, broadcasting through the network 104 can be experience (on live) in real time.

In conventional live streaming broadcasting for carrying out editing mainly using a single apparatus, for example, such as a general purpose PC, the broadcasting mode for broadcasting images and sound without applying any process thereto is a mainstream, and the expression thereof involves a great difference as compared with radio broadcasting. That is, conventionally, it has been impossible, for example, to synthesize a plurality of camera images, to insert a telop, and to perform processes for synthesizing video images (such as alpha blend process, lay over laying process).

According to the editing function provided in [symbol] WindowsMedia Encoders [symbol] which is a software for the streaming encoding made by Microsoft Inc., only one camera source is selected, and a plurality of camera images cannot be displayed simultaneously.

Further, with respect to processing images, typically, separate images are displayed on a plurality of display regions within the display screen on the clients side.

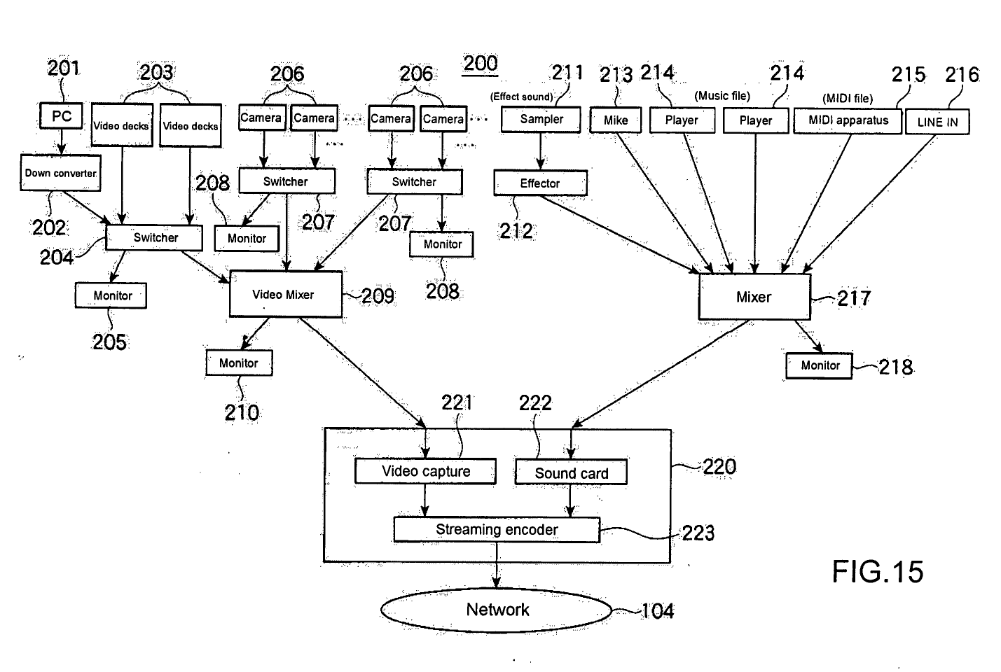

In order to synthesize a plurality of camera images, insert a telop, and perform processes for synthesizing video images (such as alpha blend process, lay over laying process), it was historically necessary to use a broadcasting system 200 provided with many broadcasting apparatuses in addition to PC 201, as shown in FIG. 15, for example.

That is, the broadcasting system 200 shown in FIG. 15 is provided, for editing images, with for example, PC 201 having display data such as a telop stored therein, a down converter 202, a plurality of video decks 203 for regenerating a video tape, a switcher 204 for selecting one out of these image data, a confirming monitor 205, a plurality of cameras 206, a switcher 207 for selecting one out of image data from the plurality of cameras 206, a confirming monitor 208, a video mixer (which performs alpha blend process, lay overlaying process, etc) for synthesizing image data from the switches 204, 207), and a monitor 210 for confirming image data after it has been synthesized by the video mixer 209.

Further, for editing voices, there is provided a sampler 211 for sampling effect sound, an effecter for applying effect process to effect sound, a microphone 213, a player 214 such as a CD player, MIDI apparatus 215 for regenerating a MIDI file, voice apparatus 216 for line-inputting voice data, a mixer 217 for mixing the voice data, and a monitor 218 for monitoring the voice data after mixing by the mixer 217.

Further, the PC 220 is provided with a video capture 221 for receiving image data from the video mixer 209, a sound card 222 for receiving voice data from the mixer 217, and a stream encoder (streaming encoder) 223 for encode-processing voice data from the sound card 222 and image data from the video capture 221 into a streaming broadcast for outputting to the network 104.

### SUMMARY OF THE INVENTION

### Problem to be Solved by the Invention

In the case of the conventional live streaming broadcasting for performing editing mainly using a single apparaetus such as a general purpose PC, there was a great difference in its image and voice from radio broadcasting, as described above.

Further, in the case of using ┌Windows Media Encoder┘, for image-switching between cameras, it is necessary to take the procedure for starting a separate camera after finishing operation of the camera selected originally. This is problematic because it takes time for switching.

Further, in the case of using a broadcasting system 200 provided with many broadcasting devices as shown in FIG. 15, the materials are costly and it takes time to install and connect the materials. In addition, in case of the broadcasting system 200, there poses a problem discussed below.

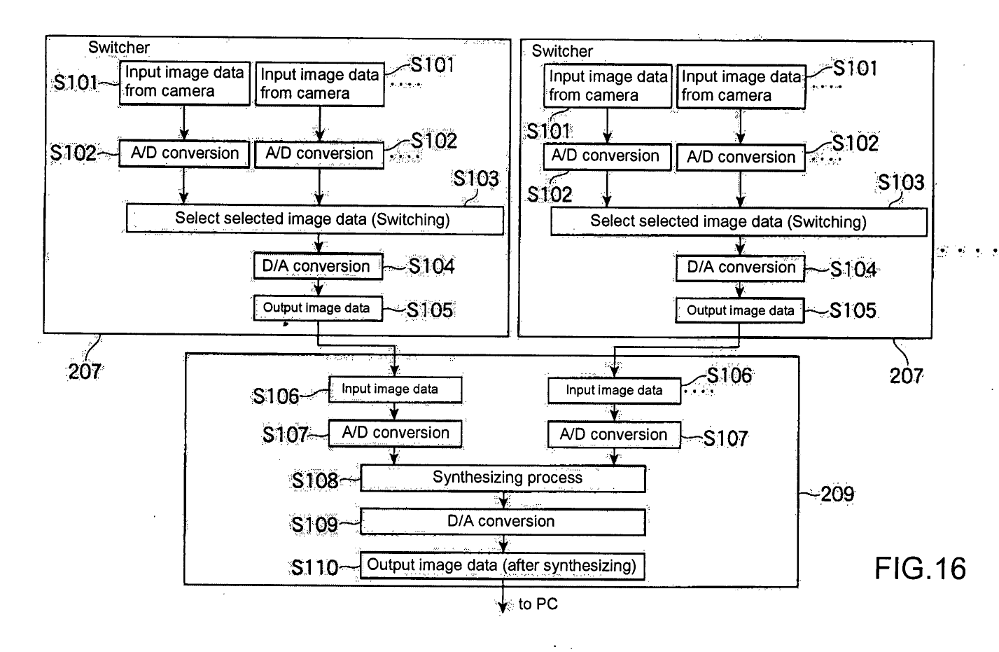

FIG. 16 is a flowchart showing a flow of processes carried out particularly in a switcher 207 and a video mixer 209, out of various broadcasting devices shown in FIG. 15.

As shown in FIG. 16, in the switcher 207, image data is input from a plurality of cameras 206 (Step S101), D/A conversion is carried out with respect to these image data (Step S102), and subsequently, image data from a camera 21 that is selected by operation of a broadcaster out of the image data are selected (Step S103). Then, the selected image data is subjected to D/A conversion (Step S104) to output it from the switcher (Step S105).

Further, in the video mixer 209, image data from the switcher 207 is respectively input (S106), which are subjected to A/D conversion with respect to the image data (Step S107). Then, the image data after A/D conversion are synthesized (Step S108), and the image data after synthesized are subjected to D/A conversion to output it to PC 220 from the video mixer 209.

That is, in the case of the broadcasting system 200, since the synthesizing process (Step S104) is carried out, it is necessary, as shown in FIG. 16, to carry out output and input of image data (Step S105 and Step S106), and it is also necessary to repeat A/D conversion (Step S102 and Step S107) and D/A conversion (Step S104 and Step S109), resulting in a lot of wastes in process. Moreover, input and output, and D/A conversion are repeated, thus posing a problem of increasing possibility that noses are produced in image data.

Further, for inserting a telop in the conventional live streaming broadcasting, it is necessary to prepare display data for a telop in advance to store it in PC201, which is troublesome, and failing to correspond thereto in the case where a telop becomes necessary suddenly.

Further, in the conventional live streaming broadcasting, it is merely that one dimensional broadcasting from a single streaming server 106 can be audited. Therefore, it was not possible to audit multi-dimensional broadcasting from a plurality of streaming servers 106.

In the live streaming broadcasting, there is a problem that for the convenience' sake of data amount that can be processed, it is difficult to use excessively large image data for broadcasting. Therefore, it has been desired to be data amount processed as small as possible, as well as broadcasting contents excellent in expression.

Furthermore, also in various broadcastings not limited to the live streaming broadcasting, a broadcasting method in novel expression that not found in prior art has been desired.

The present invention has been accomplished in order to solve the problems as noted above, and has its object to provide a live streaming broadcasting method, a live streaming broadcasting apparatus, a live streaming broadcasting system, programs, a recording medium, a broadcasting method and a broadcasting apparatus, which realize broadcasting in high expression at low cost, or in novel expression not obtained so far.

### Means for Solving the Problem

For solving the aforesaid problems, the live streaming broadcasting method of the present invention is a live streaming broadcasting method for carrying out a live broadcasting through a network, characterized in that, while inputting a plurality of camera image data, synthesized image data obtained by synthesizing process for synthesizing a plurality of camera image data during inputting are output for auditory by clients.

Further, the live streaming broadcasting method of the present invention is a live streaming broadcasting method for carrying out a live broadcast through a network, such that while receiving the other live streamingbroadcast, image data of the live streaming broadcast during receiving is output for auditory by clients.

In this case, preferably, while receiving a plurality of said other live streamingbroadcasts, synthesized image data obtained by the synthesizing process for synthesizing image Data of said plurality of live streaming broadcasts during receiving are output to the clients.

Further, the live streaming broadcasting method of the present invention is a live streaming broadcasting method for carrying out a live broadcast through a network, whereby while inputting camera image data, synthesized image data obtained by the synthesizing process for synthesizing the other image data to the camera image data during inputting is output to the network for auditing by a client.

Further, the live streaming broadcasting method of the present invention is characterized in that at least either one out of static image data and video image data is included in the other image data.

Further, the live streaming broadcasting method of the present invention is characterized in that text display data input by operation during broadcasting is included in the other image data.

Further, the live streaming broadcasting method of the present invention is characterized in that image data produced on the basis of designated information which is for designating image display but not image data is included in the other image data.

Further, the live streaming broadcasting method of the present invention is characterized in that plug-in data is included in the other image data.

Further, the live streaming broadcasting method of the present invention is characterized in that the synthesizing process is an alpha blend process or picture-in-picture process.

Further, the live streaming broadcasting method of the present invention is a live streaming broadcasting method for carrying out a live broadcast through a network, whereby text display data input by operation during broadcasting is output to the network for listening to by clients.

Further, the live streaming broadcasting method of the present invention is a live streaming broadcasting method for carrying out a live broadcast through a network, whereby image data corresponding to the live streaming broadcasting method of the present invention is characterized in that image data produced on the basis of designated information which is for designating image display but not image data is output to the network for listening to by clients.

Further, the live streaming broadcasting method of the present invention is a live streaming broadcasting method for carrying out a live broadcast through a network, wherein plug-in data is output to the network for listening to by clients.

Further, the live streaming broadcasting method of the present invention is a live streaming broadcasting method for carrying out a live broadcast through a network, wherein link-addressed information of a browser on the broadcaster side is output as a script, and the link address of the browser on the clients side is designated on the basis of the script of said link addressed information to thereby switch the link address synchronously with the broadcaster side.

Further, the live streaming broadcasting method of the present invention is a live streaming broadcasting method for carrying out a live broadcast through a network, whereby position information displayed on the browser on the broadcaster side is output as a script, and a display position of a pointer on the browser on the clients side is designated on the basis of the script of said position information to thereby associate a display position of the pointer on the clients side with the broadcaster side.

Further, the live streaming broadcasting method of the present invention is a live streaming broadcasting method for carrying out a live broadcast through a network, whereby image data of images depicted by operation of the broadcaster on the browser on the broadcaster side are output to the network for listening to by clients.

Further, the live streaming broadcasting method of the present invention is characterized in that the image data of images depicted by operation of the broadcaster are synthesized with animation image data to output them to the network.

Further, the live streaming broadcasting apparatus of the present invention is a live streaming broadcasting apparatus for carrying out a live broadcasting method through a network comprising synthesizing processing means for executing the synthesizing process in an either live streaming method of the present invention, and output means for executing said output to said network.

Further, the live streaming broadcasting apparatus of the present invention is a live streaming broadcasting apparatus for carrying out a live broadcasting method through a network comprising receiving means for receiving the other live streaming broadcast through the network, and output means for outputting image data of the live streaming broadcast during receiving to the network for listening to by clients.

Further, the live streaming broadcasting apparatus of the present invention is a live streaming broadcasting apparatus for carrying out a live broadcasting method through a network comprising output means for outputting text display data input by operation during broadcasting to the network for auditing by clients.

Further, the live streaming broadcasting apparatus of the present invention is a live streaming broadcasting apparatus for carrying out a live broadcasting method through a network, comprising output means for outputting image data produced on the basis of designated information which is for designating image display but not image data to the network for auditing by clients.

Further, the live streaming broadcasting apparatus of the present invention is a live streaming broadcasting apparatus for carrying out a live broadcasting method through a network, comprising output means for outputting plug-in data to said network for auditory by clients.

Further, the live streaming broadcasting apparatus of the present invention is a live streaming broadcasting apparatus for carrying out a live broadcasting method through a network, wherein link-addressed information of a browser on the broadcaster side is output as a script, and the link address of a browser on the clients side is designated on the basis of the script of said link addressed information to thereby switch the link address synchronously with the broadcaster side.

Further, the live streaming broadcasting apparatus of the present invention is a live streaming broadcasting apparatus for carrying out a live broadcasting through a network, wherein position information displayed on the browser on the broadcaster side is output as a script, and a display position of a pointer on the browser on the clients side is designated on the basis of the script of said position information to thereby associate a display position of the pointer on the clients side with the broadcaster side.

Further, the live streaming broadcasting apparatus of the present invention is a live streaming broadcasting apparatus for carrying out a live broadcast through a network, characterized by comprising output means for outputting image data of image depicted by operation of the broadcaster on the browser on the broadcaster side are output to said network for auditory by clients.

Further, the live streaming broadcasting apparatus of the present invention may comprise synthesizing means for synthesizing said image data of image depicted by operation of the broadcaster with animation image data, and said output means outputs image data after synthesized by said synthesizing means to said network.

Further, the live streaming broadcasting system of the present invention may comprise a live streaming broadcasting apparatus of the present invention, and a streaming server for delivering image data output from said live streaming broadcasting apparatus to clients.

Further, the program of the present invention is a program that can be read by a computer, and plural cameral synthesizing process for synthesizing a plurality of image data input in apparatus provided with said computer is allowed to be executed by said computer, characterized in that switching process for selecting camera image data in order to selectively apply a suitable plurality of camera image data out of three camera image data or more input in said apparatus, and output process for outputting synthesized image data produced by said plural cameral synthesizing process from said apparatus are allowed to be executed in that order by said computer.

Further, the program of the present invention is a program that can be read by a computer, characterized in that synthesizing process in the streaming broadcasting method of the present invention and said output to said network are allowed to be executed by said computer.

Further, the program of the present invention is a program that can be read by a computer, characterized in that process for receiving a live streaming broadcasting through a network, and process for outputting the live streaming broadcasting during receiving to said network for auditory by clients are allowed to be executed by said computer.

Further, the program of the present invention is a program that can be read by a computer, and the live streaming broadcasting through a network is allowed to be executed by said computer, characterized in that process for outputting text display data input by operation during broadcasting of the live streaming broadcasting to said network for auditory by clients is allowed to be executed by said computer.

Further, the program of the present invention is a program that can be read by a computer, and the live streaming broadcasting through a network is allowed to be executed by said computer, characterized in that process for outputting image data produced on the basis of designated information that is for image display designation but not image data to said network for auditory by clients is allowed to be executed by said computer.

Further, the program of the present invention is a program that can be read by a computer, and the live streaming broadcasting through a network is allowed to be executed by said computer, characterized in that process for outputting plug-in data to said network for auditory by clients is allowed to be executed by said computer.

Further, the program of the present invention is a program that can be read by a computer, and the live streaming broadcasting through a network is allowed to be executed by said computer, characterized in that process for outputting link address information of browser on the broadcaster side, designating a link address of browser on the clients side on the basis of a script of said link address information, and thereby synchronously switching the link address on the clients side to the broadcaster side.

Further, the program of the present invention is a program that can be read by a computer, and the live streaming broadcasting through a network is allowed to be executed by said computer, characterized in that process for outputting, as a script, position information of a pointer displayed on browser on the broadcaster side, designating a display position of the pointer on the browser on the clients side on the basis off said position information, and thereby associating the display position of the pointer on the clients side with the broadcaster side is allowed to be executed by said computer.

Further, the program of the present invention is a program that can be read by a computer, and the live streaming broadcasting through a network is allowed to be executed by said computer, characterized in that process for outputting image data of image depicted by operation of the broadcaster on the browser on the broadcaster said network for auditory by clients is allowed to be executed by said computer.

The program of the present invention is a program that can be read by a computer is characterized in that process for outputting image data including plug-in data to a broadcasting network for auditory by clients is allowed to be executed by said computer.

Further, the recoding medium of the present invention is characterized in that the program of the present invention is recorded.

Further, the broadcasting method of the present invention is characterized in that image data including plug-in data are output to the broadcasting network for auditory by clients.

Further, the broadcasting apparatus of the present invention is characterized by comprising output means for outputting image data including plug-in data to the broadcasting network for auditory by clients.

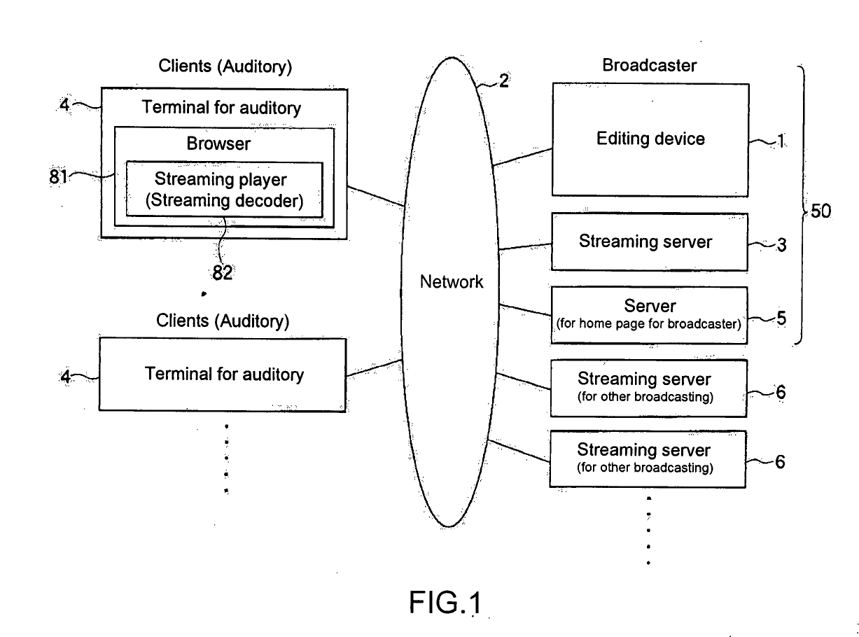

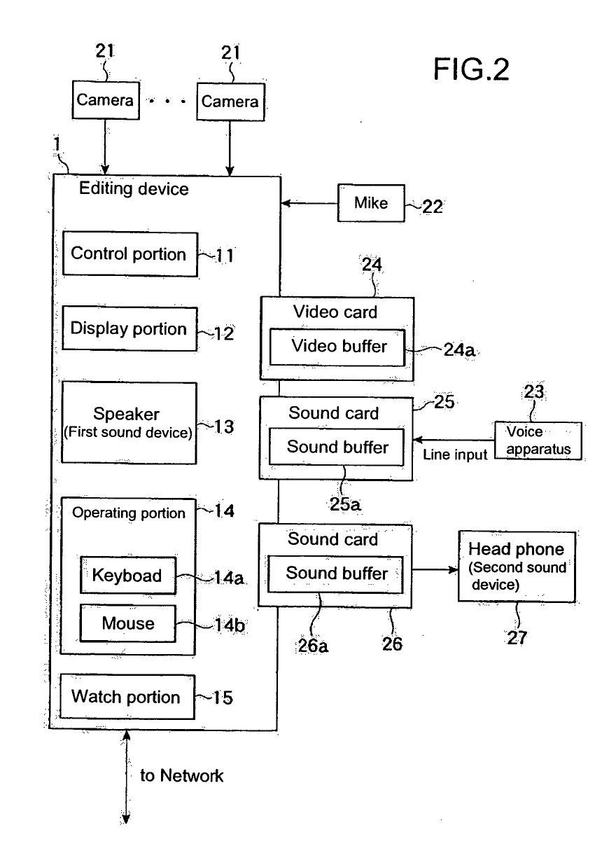

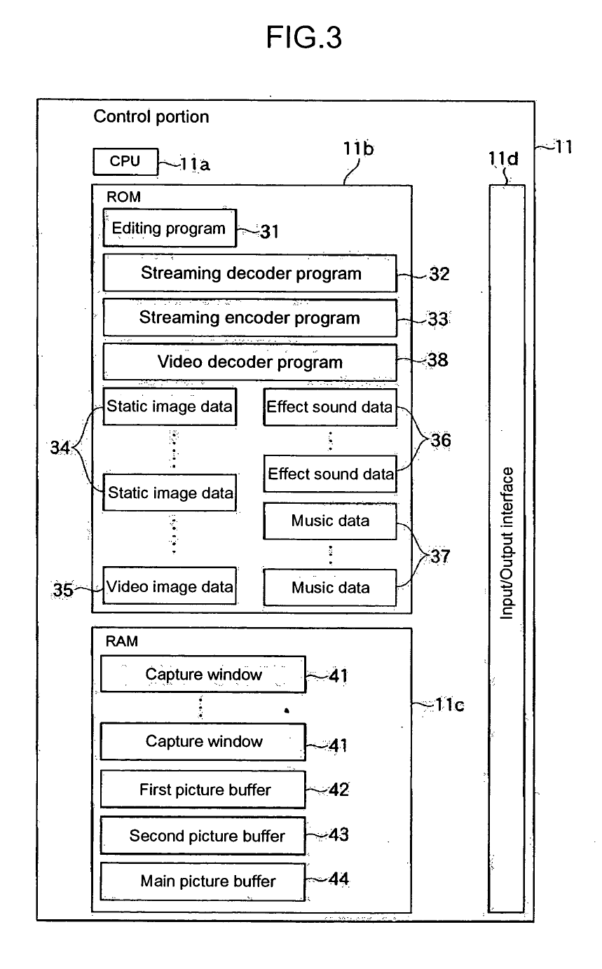

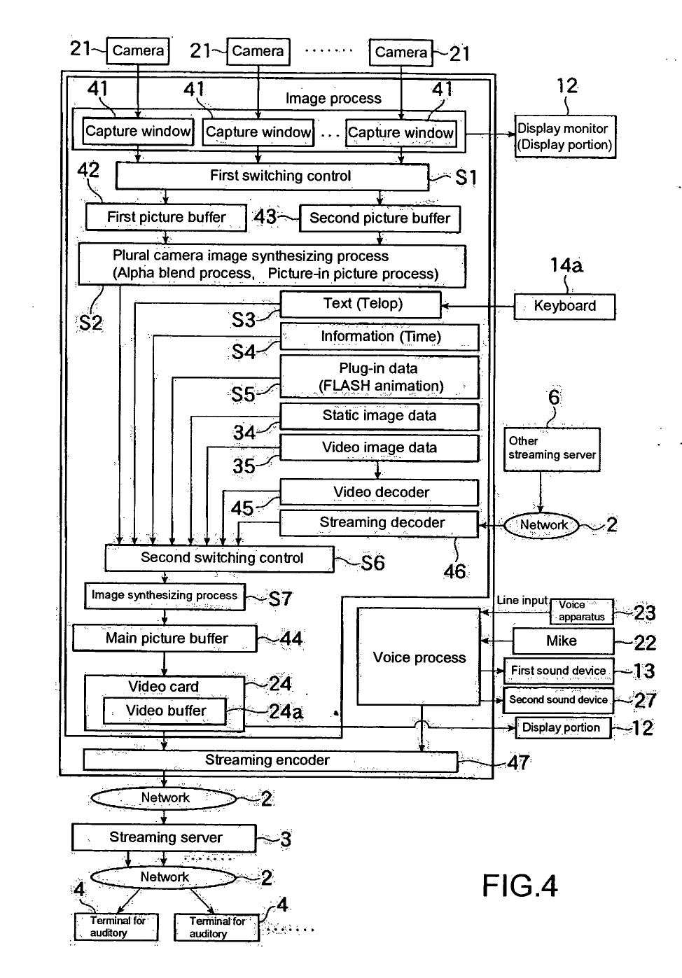

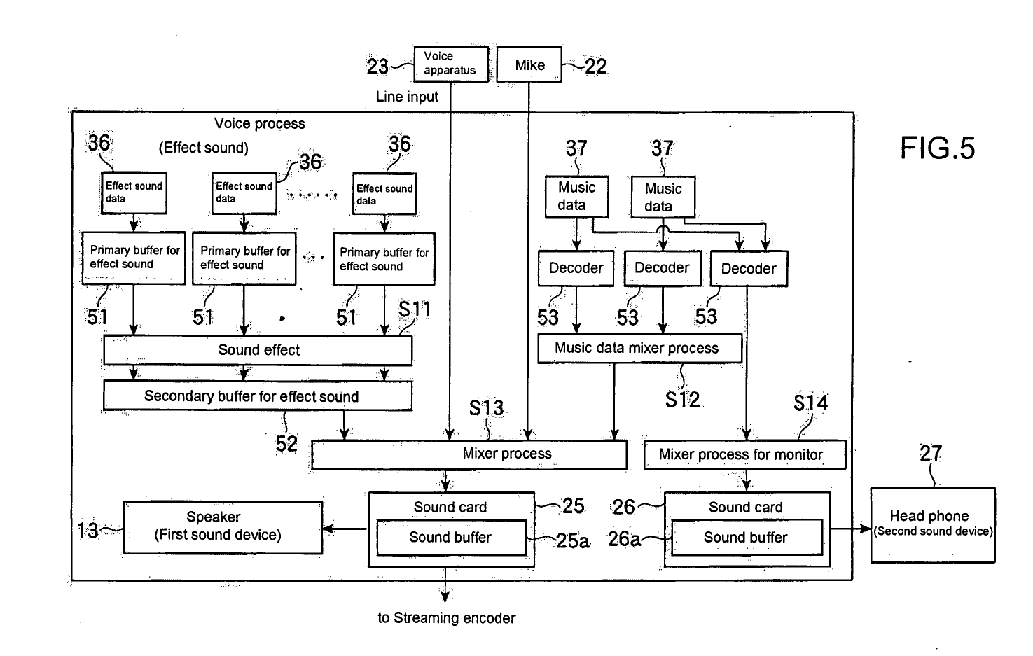

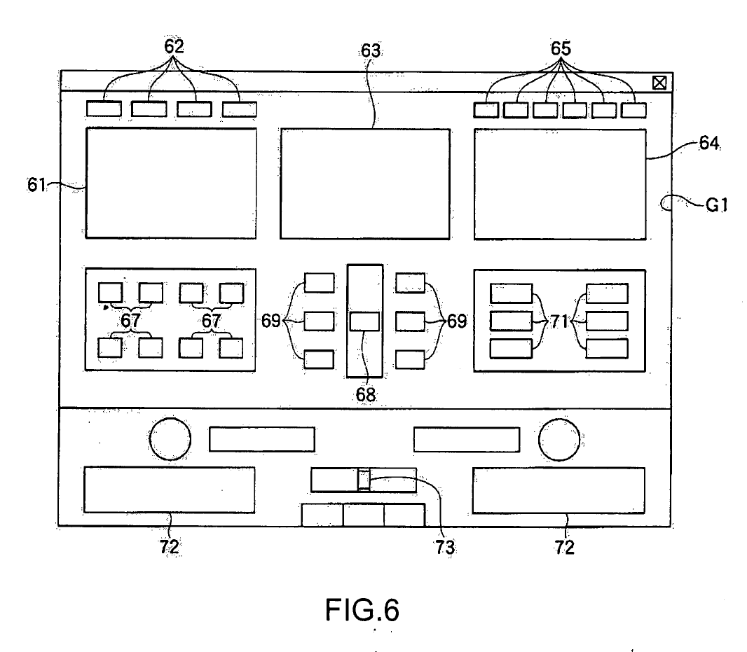

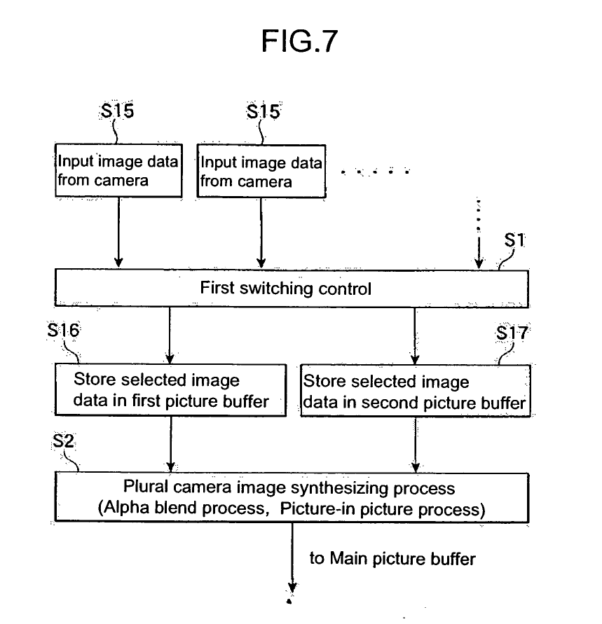

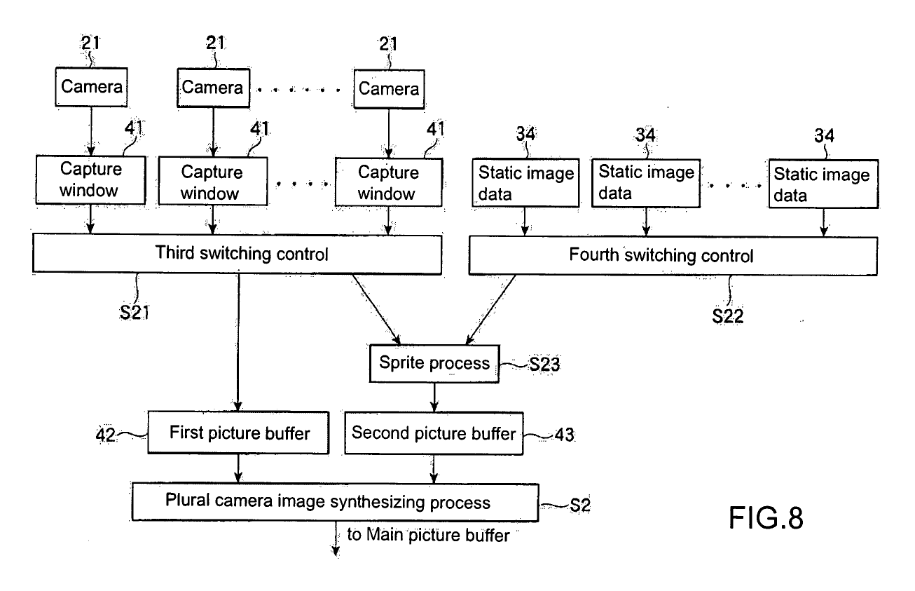

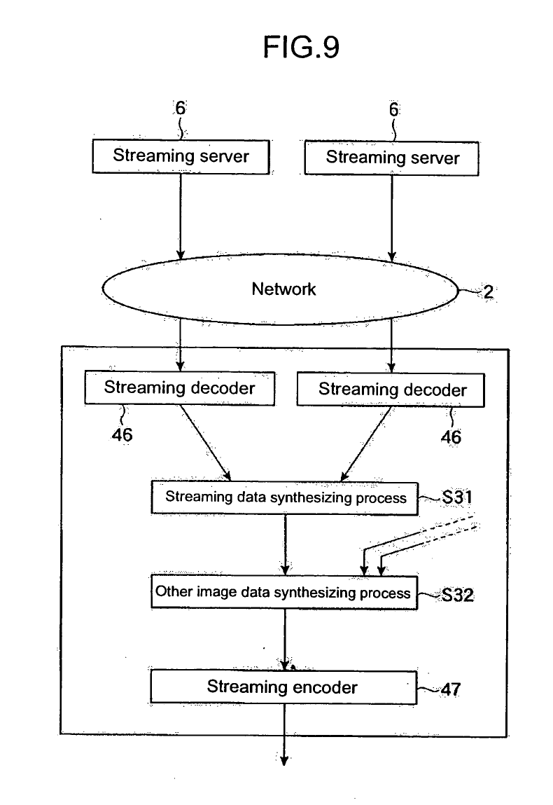

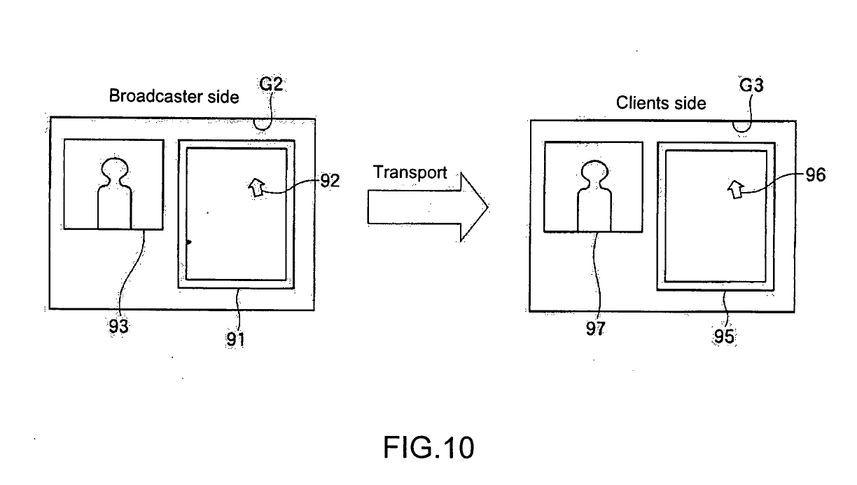

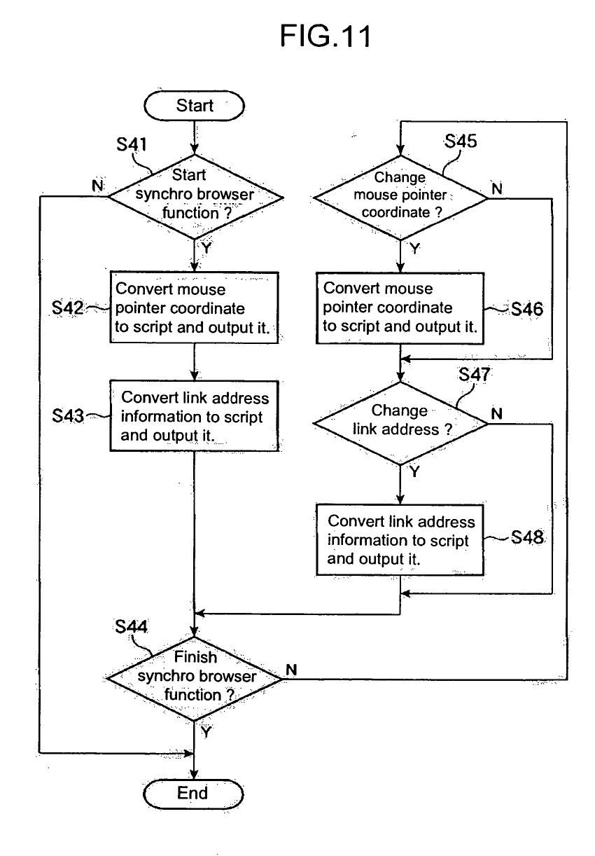

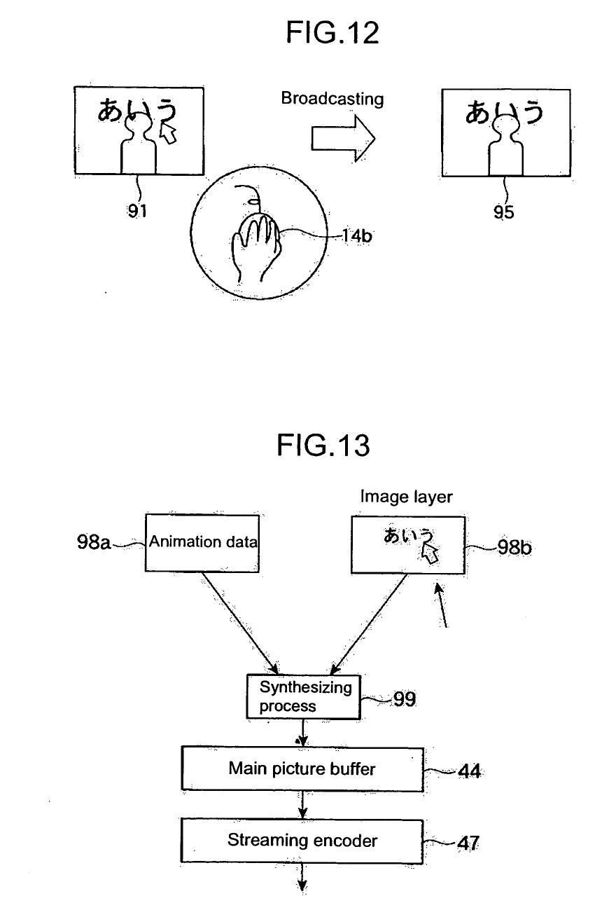

### BRIEF DESCRIPTION OF THE DRAWINGS

[FIG. 1] A block diagram for explaining a streaming broadcasting method according to the embodiment of the present invention.

[FIG. 2] A block diagram showing an editing device and its peripheral devices used for a streaming broadcasting method.

[FIG. 3] A view showing main block structure of a control portion provided in the editing device.

[FIG. 4] A flowchart for explaining a flow of process with respect to image data of editing process carried out by the editing device.

[FIG. 5] A flowchart for explaining a flow of process with respect to voice data out of editing process carried out by the editing device.

[FIG. 6] A view showing a screen display example of a display portion of an editing device during editing process.

[FIG. 7] A flowchart for explaining a flow of plural camera image synthesizing process particularly out of editing process.

[FIG. 8] A flowchart for explaining an example of process in case of carrying out sprite process.

[FIG. 9] A flowchart for explaining a flow of process in case of synthesizing and outputting live streaming broadcasting receiving from a plurality of other streaming servers.

[FIG. 10] A view showing a screen display example in case of executing syncro-browser function and synchro-pointer function.

[FIG. 11] A flowchart for explaining the syncro-browser function and synchro-pointer function.

[FIG. 12] A view showing a screen display example in case of executing hand-written function.

[FIG. 13] A flowchart for explaining the hand-written function.

[FIG. 14] A block diagram for explaining a flow of process in a conventional live streaming broadcasting.

[FIG. 15] A block diagram in case, of carrying out live broadcasting using a number of broadcasting materials in prior art.

[FIG. 16] A flowchart for explaining a flow of main parts in case of technique of FIG. 15.

According to the present invention, broadcasting which is high in expression at low cost can be executed.

Or, broadcasting in novel expression that cannot be obtains so far can be realized.

### DETAILED DESCRIPTION OF THE PREFERRED EMBODIMENTS

The embodiments according to the present invention will be described hereinafter with reference to the drawings.

### First Embodiment

FIG. 1 is a flowchart showing various structural elements for realizing the streaming broadcasting method according to the present embodiment.

As shown in FIG. 1, in the streaming broadcasting method according to the present embodiment, in the editing apparatus (streaming broadcasting apparatus) 1 on the broadcaster side, while producing image data and voice data by an editing process, the image data and voice data to be produced, that is, image data and voice data after the editing process are continuously output as broadcasting data to a streaming server 3 through a network 2. Here, the streaming server 3 at output address is designated in advance by the input of an IP (Internet protocol) by the broadcaster or selecting work. Further, the network 2 can be the internet, a LAN, a communication network of a portable information terminal, and the like. Further, the editing apparatus 1 can take the form of, but is not limited to, a general purpose PC (Personal Computer).

On the other hand, in a terminal for auditory 4 on the clients side, while continuously receiving image data and voice data (broadcasting data) from the streaming server 3. through the network 2, they are displayed on a display portion of the terminal for auditory 4, and output from a speaker of the terminal for auditory 4.

Thereby, the clients are able to audit images based on image data from the broadcaster side continuously and at real time through the network 2.

The terminal for auditory 4 can take the form of, but is not limited to, a portable information terminal apparatus such as a PDA or as a portable telephone, in addition to a general purpose PC.

At the time of auditing, for example, the clients get access to a home page prepared in advance by the broadcaster side and click [symbol] broadcasting start button [symbol] within the home page to thereby enable (display and voice output) broadcasting. Broadcasting can also be started simply by getting access to the home page on the broadcaster side. At this time, a streaming layer 82 (including a streaming decoder) is started so that an image display of broadcasting is done within a player screen, or an image display is done within a screen of the browser 81. As described, for getting access to the home page to do auditing, the broadcaster stores data of the home page in advance in a server 5 (a server for the home page separate from the streaming server 3).

It is noted that the other streaming server 6 (FIG. 1) for broadcasting is a streaming server (for example, for the other broadcaster) in order to perform live streaming broadcasting by image data output from apparatus other than the editing apparatus 1.

In the foregoing, transmit/receive of broadcasting data (transmit/receive between editing apparatus 1→streaming server 3, and between streaming server 3→terminal for auditory 4) is carried out by designating transmit/receive ends by IP (Internet Protocol).

FIG. 2 is a block diagram showing the editing apparatus 1 and its peripheral apparatus.

As shown in FIG. 2, camera image data from a plurality (for example, six) of cameras 21 is input into the editing apparatus on the broadcaster side. It is noted that the camera 21 may be a camera for outputting camera image data as digital data. It may be one for outputting as analog data. In the case of using the camera 21 for outputting as analog data, in the editing apparatus 1, editing apparatus (described later) is applied to camera image data to be input after A/D conversion.

Further, in the editing apparatus 1, voice data from a microphone is input, or voice data from external voice data outputting apparatus 23 is line-input. It is noted that the external voice data outputting apparatus 23 may be, for example, CD (Compact Disk) player or MD (Mini Desk) player.

In addition, a video card 24 for processing image data, sound cards 25, 2 for processing voice data are inserted into the editing apparatus 1.

Further, for example, a head phone (second sound device) as a voice monitor is connected to the editing apparatus 1.

Further, the editing apparatus is provided with a display portion 12 for displaying an operation screen G1 (FIG. 6) including a display region of image data before editing (source image data) and images (images o be broadcast) after editing, a speaker (first sound device) 13 for outputting, for example, voice after editing, an operation portion 14 for carrying out the editing operation, a clock portion 15 for carrying out time checking and time measuring, and a control portion 11 for carrying out the editing process or display control of the display portion 12 according to the operation with respect to the operation portion 14, being connected to the network 2.

The display portion 12 comprises, for example. A liquid crystal display device or a display device of a cathode-ray tube system. Outputting of display data (image data) to the display portion 12 is carried out through a video buffer 24a of the video card 24.

Further, outputting of voice data to the speaker 13 is carried out through a sound buffer 25a of the sound card 25.

Further, the operation portion 14 is constructed by being provided with a keyboard 14a and a mouse 14b.

Further, the control portion 11 is, as shown in FIG. 3, constructed by being provided with CPU (Central Processing Unit), ROM (Read Only Memory) 11b, RAM (Random Access Memory) 11c and an input/output interface 11d.

CPU 11a is provided with an operating portion and a control portion, and programs stored in the ROM 11b are executed to thereby perform editing process of broadcasting data (image data and voice data), output process of broadcasting data to the network 2, output process of voice data to the head phone 27, and operation control of the display portion 12 and the speaker 13.

In the ROM (recording medium) 11b are stored programs for operation and control, and data used for exiting.

The programs stored in ROM 11b include, for example, an editing program 31, a streaming decoder program 32, a streaming encoder program 33, and a video decoder program 38.

Further, data for editing stored in ROM 11b include, for example, static image data 34, video image data 35, sound effect data 36 and music data 37. Among them, the static image data 34 is, for example, JPEG; the video image data 35 is, for example, AVI or mpeg; the sound effect data 36 is, for example, a WAVE file; and the music data 37 is, for example, a WAVE file, mp3, WMA or MIDI.

RAM 11c is provided with a work region for CPU 11a. In editing, in accordance with the editing program 31, RAM 11c is formed, for example, with a capture window 41, a picture buffer (for example, two picture buffers comprising a first picture buffer 42 and a second picture buffer), and a main picture buffer 44 for temporarily storing image data after all image synthesizing processes have been finished. It is noted that the number of the picture buffers is the number corresponding to that of image data to be synthesized. That is, if the number of image data to be synthesized is 3 or more, the number of picture buffers is also 3 or more.

In the above-described structure, a live streaming broadcasting system 50 according to the present embodiment is constructed by the editing apparatus 1, camera 21, mike 22, video card 24, sound cards 25, 26, voice apparatus 23, head phone 27, streaming server 3 and server 5.

In the following, various processes carried out by CPU 11a on the basis of the execution of the programs will be described.

<Process Based on the Execution of the Video Decider Program 38>

CPU 11a performs the process for decoding video image data 35 as a video decoder 45 (FIG. 4) (video decoder process).

<Process Based on the Execution of the Video Decider Program32>

CPU 11a performs the process for decoding video image data 35 as a video decoder 45 (FIG. 4) (video decoder process).

<Process Based on the Execution of the Streaming Decider Program33>

CPU 11a performs the process for decoding live streaming broadcasting data received from the other streaming server 6 through the network 2 as a streaming decoder 46 (FIG. 4) (streaming decoder process).

<Process Based on the Execution of an Editing Program>

In the following, there are listed processes performed by CPU 11a based on the execution of the editing program.

“Capture window producing process”

Process for producing capture windows 41 (in case of the present embodiment, concretely, for example, 6 capture windows 41) so as to correspond to a plurality (in case of the present embodiment, concretely, for example, 6) of cameras 21 in 1:1.

“First switching control process”

Process for selecting data for storage to a first buffer picture buffer 42 and a second picture buffer 43 out of camera image data received in the capture window 41.

However, in case where only (one) camera image data from one camera 21 is used for editing, the one camera image data is selected for storage in the first picture buffer 42.

“Picture buffer storage process”

Process in which camera storage data selected for storage in the first picture buffer by switching control, and camera storage data selected for storage in the second picture buffer are temporarily stored in the first picture buffer 42 and the second picture buffer 43, respectively.

In case where only (one) camera image from one camera 21 is used for exiting, the one camera image data is stored in the first picture buffer 42, and camera image data is not stored in the second picture buffer.

“Plural camera image synthesizing process”

Plural camera image synthesizing process for synthesizing camera image data stored in the first and second picture buffers 42, 43 to produce synthesized image data (Step S2 in FIG. 4). This plural camera image synthesizing process, concretely, include, for example, alpha blend process and picture-in-picture process. Among them, the alpha blend process is a process for synthesizing a plurality of images in a half-transparent state to synthesize them. For example, by using the alpha blend process such that while one transparency of image is gradually made higher, the other transparent of image is gradually made lower to thereby enable switching between the cameras 21 without difference. Further, the picture-in-picture process is a process for displaying the other image in one image on a small window, which is able to display images of a plurality of cameras 21 simultaneously.

It is noted that in case where camera image data selected by the first switching control process (Step S1) is only one, the plural camera image synthesizing process is not executed.

“Process for producing data for a telop”

Process for producing display data, as a telop, of text data input by operation of the keyboard 14a to insert (synthesize) in camera image at real time (Step S3 in FIG. 4).

“Process for producing display data for information”

Process for producing, as display data for information, display data on the basis of information applied to display designation (for example, time, camera position and lap time (in race), score in sport game relay) (Step S3 in FIG. 4)

“Plug-in data producing process”

Process for producing plug-in data (for example, FLASH animation) (Step S5 in FIG. 4).

“Static image data obtaining process”

Process for obtaining static image data 35 selected.

“Second switching control process

Process for selecting, for synthesizing process (Step S7 in FIG. 4, described later), at least one of image data selected by data producing process for a telop (Step S3 in FIG. 4), data producing process for information (Step S4 in FIG. 4), plug-in data processing process (Step S6 in FIG. 4), static image data obtaining process, video decoder process and trimming decoder process.

“Image synthesizing process”

Process for further synthesizing (Step S7 in FIG. 4) image data selected by second switching control process, synthesized image data produced by plural camera image synthesizing process (Step S2). The image data produced by this image synthesizing process is display data of image which is the same as that is broadcasted.

It is noted that where the plural camera image synthesizing process is not executed, In this image synthesizing process, there is carried out process for synthesizing camera image data from the first picture buffer 42, and image data selected by the second switching control process.

“Main picture buffer storage process”

Process for temporarily storing image data produced by the image synthesizing process (Step S7) in the main picture buffer 44.

Video buffer storage process”.

Process for storing image data from the main picture buffer 44 in a video buffer 24a of the video card 24.

“Primary buffer storage process for effect sound”

Process for storing effect sound data 36 selected in a primary buffer 51 for effect sound (FIG. 5).

“Sound effect process”

Process (Step S11 in FIG. 5) for applying sound effect to effect sound data 36 selected.

“Secondary buffer storage process for effect sound”

Process for collecting effect sound data 36 after sound effect process (Step S11) to store them in a secondary buffer 52 for effect sound.

“Music data decode process”

Process for decoding selected music data 37 as a decoder 53.

“Music data mixer process”

Process for mixing a plurality of music data 37 decoded by a decoder 53.

“Mixer process”

Process for mixing effect sound data 36 from a secondary buffer 52 for effect sound, voice data from voice apparatus 23, voice data from a mike 22, and music data after music data mixer process to thereby produce the dame voice data as that is broadcasted (Step S13 in FIG. 5).

“First sound buffer storage process”

Process for temporarily storing voice data after mixer process (Step S13) in a sound buffer 25a of the sound card 25.

“First sound device output process”

Process for outputting music data stored in the sound buffer 25a to a speaker 13 as a first sound device.

“Mixer process for mixer”

Process for mixing music data selected for monitor (Step S14 in FIG. 4).

“Second sound buffer storage process”

Process for temporarily storing music data after the mixer process for monitor (Step S14) in a sound buffer 26a of the sound card 26.

“Second sound device output process”

Process for outputting music data stored in the sound buffer 26a in a head phone 27 as a second sound device.

“Operating screen display process”

Process for displaying an operation screen G1 of FIG. 1 on the display screen of the display portion 12.

Here, the function of various display regions formed in the operation screen G1 and operating buttons will be described referring to FIG. 6.

That is, the operation screen G1 is formed with a display region 61 for carrying out image display on the basis of camera image data from any of camera 21 selected out of a plurality of cameras 21, an operating button 62 for switching camera images display on the display region 61, a display region 63 for displaying an image (image based on image data after image synthesizing process of Step S7) that is the same as that to be broadcasted or selected plug-in data (at the time of selection), a display region 64 for displaying an operating window for executing various functions such as telop input, an operating button 65 for switching various functions using the display region 64, a cross fader operating portion 68 for images for carrying out switching between cameras 21, an operating button 69 for adding image effects such as picture-in picture, telop insertion, static image synthesizing and the like, an operating button 71 for selecting effect sound data 36, a display region 72 for displaying a list of selection candidate of music data 37, a speaker 13, and a cross fader operating portion 73 for voices for adjusting sound amount of he head phone 27.

It is noted that the operating buttons 62, 65, 67, 69, 71 can be operated by clicking them using a mouse 14b, and the cross fader for images 68 and the cross fader operating portion for voices 73 can be operated by dragging them using a mike 14b.

Further, the image data of images displayed on the display region 11 are input in the display portion 12 through the video buffer 24a of the video card 24 from any of the capture windows 41 selected, and displayed on the basis of the image data (In FIG. 4, for the simple sake, the video card 24 in a signal channel to the display portion 12 from the capture window 41 is omitted.).

In the following, an example of concrete operation will be described.

### FIRST OPERATING EXAMPLE

In the first operating example, a description will be made of the case where while inputting one image data from one camera 21, synthesized image data obtained by synthesizing other image data to said camera image data during inputting is output to a network 21 for auditory by clients.

In this case, in a first switching control (Step S1), only the camera image data received in any one of capture window 41 is selected for storage to a first picture buffer 42. Plural camera image synthesizing process S2 is not applied to camera image data read from the first picture buffer 42, but said camera image data is applied without modification to image synthesizing process (Step S7).

On the other hand, in a second switching control (Step S6), at least one image data obtained by data producing process for a telop (Step S3), display data producing process for information (Step S4), plug-in producing process (Step S5), static image obtaining process, video decoder process, and streaming decoder process.

Further, in image synthesizing process (Step S7), image data selected by a second switching control (Step S6), and image data from a first picture buffer 42 are synthesized. Thereby, data for display of the same image as that is broadcasted is produced.

Image data after image synthesizing process is stored in a main picture buffer 44, and further stored in a video buffer 24a.

Image data of the video buffer 24a are output to a display portion 12 for monitor, and applied to display in a display region 63 (FIG. 6), and are output also for encode process by a streaming encoder 47.

On the other hand, voice data from voice apparatus or a mike 22, effect sound data 36 having sound effect process applied, and at least any of voice data out of music data 37 to which decode process is applied are made to the same voice data as that are broadcasted by mixer process (Step S13), after which they are output for encode process by a streaming encoder 47.

In the streaming encoder 47, image data from a video buffer 24a and voice data from a sound buffer 25a are encoded for streaming broadcasting, and data (broadcasting data) after encoding are output continuously to a network 2.

Also, on the clients side, a browser 81 (FIG. 1) is started in a terminal for auditory 4 to get access to a home page of the broadcaster, and display data of the home page is obtained by a server 5 (server for the home page of the broadcaster).

And, screen display of the home page is started, or ┌broadcasting start button┘ formed in a display screen of the home page is clicked to thereby start live streaming broadcasting. At that time, in a terminal for auditory 4, a streaming player (streaming decoder) 82 is started. The streaming player 82 performs image display based on image data received continuously from a streaming server 43, and outputs voice data based on voice data received continuously from a streaming server 3 from a speaker of a terminal for auditory 4. Thereby, clients are able to audit live streaming broadcasting.

As described above, according to the first operating example, the clients are able to audit images based on synthesized data obtained by synthesizing other image data with camera image data.

### SECOND OPERATING EXAMPLE

In the second operating example, a description will be made of the case where while inputting a plurality of image data, synthesized image data obtained by synthesizing a plurality of image data during inputting is output to a network for auditory by clients.

In this case, in a first switching control (Step S1), camera image data received in any one of capture window 41, and camera image data received in any of other capture window 42 are selected for storage to a first picture buffer 42, and for storage to a second picture buffer 43, respectively. Further, plural camera image synthesizing process (Step S2) is applied to the camera image data read from the first and second picture buffers 42, 43 to thereby produce synthesized image data.

Further, in this case, in a second switching control (Step S6), at least any one of image data may be selected, similarly to the case of the first operating example, or any one of image data may not be selected.

In image synthesizing process (Step S7), in the case of selecting anyone of image data in a second switching control, there is carried out process for synthesizing the selected image data, and synthesized image data after plural camera image synthesized process. On the other hand, in the case of not selecting any of image data in the second switching control, the image synthesizing process (S7) is not carried out, but synthesized image data after plural camera image synthesizing process is stored without modification in a main picture buffer 44.

Also, in the second operating example, voice process and thereafter image process are similar to that of the first operating example.

Out of operation in the second operating example, process from image data input from camera 21 to plurality camera image synthesizing process (Step S2) will be described with reference to a flowchart of FIG. 7.

First, image data are input from camera 21 and received in capture window 41 (Step S15). It is noted that where image data from camera 21 is analog data, in Step (S15), A/D conversion is applied to image data before receipt into the capture window 41.

Next, a first switching control process (Step S1) is applied to each image data.

Next, camera image data selected in the first switching control process are stored in the first and second picture buffers 42, 43 (Steps S16, S17).

Next, the plural camera image synthesizing process (Step S2) is applied to image data stored in the first and second picture buffers 42, 43.

Further, image data after plural camera image synthesizing process are output to a network 2 after having been applied with encode process by a streaming encoder 47 through a main picture buffer 44 and a video buffer 24a.

As described, according to the second operating example, it is possible to carry out process for synthesizing a plurality of camera images, without carrying out input/output of image data between a plurality of broadcasting apparatuses or repeatedly carrying out A/D conversion and D/A conversion. That is, wasteful matter of process in prior art can be eliminated, and there occurs no noise in image data due to repeating of A/D conversion and D/A conversion.

### THIRD OPERATING EXAMPLE

In the third operating example, concrete operation in case of inputting (insertion) by operation during broadcasting will be described.

In this case, the broadcaster operates an operating button 65 corresponding to telop input to switch display in a display region 64 to an operating window for telop input. Thereby, process for producing data for telop (Step S3) becomes enabled.

In the process for producing data for telop, in the operating window for telop input, telop input place is selected, for example, by a mouse pointer, letters are input in a frame (text box) for telop input displayed on the selected place by operating a keyboard 14a, and a button corresponding to [symbol] telop display [symbol] out of operating buttons 69 is clicked. Then, in the second switching control (Step S6), image data (that is, display data of telop) obtained by the process for producing data for telop is selected.

In this manner, telop can be inserted into image at real time by editing work while executing live streaming broadcasting.

As described, according to the third operating example, since telop can be inserted into the image at real time, it is not necessary prepare display data for telop in advance to store it, different from the case of prior art (FIG. 15), and it is possible to carry out insertion of telop in a simple manner. Further, also in the case where telop becomes necessary suddenly, one can correspond thereto immediately.

### FOURTH OPERATING EXAMPLE

In the fourth operating example, image data produced on the basis of designated information (for, example, time information, camera position information, score information in game of sports or the like) that is for image designation but not image data is synthesized with camera image data.

In this case, for example, when [symbol] watch display button [symbol] [symbol] not shown [symbol] formed in an operating screen G1 is clicked, time information is obtained from a time portion 15, and image data for time display is produced on the basis of the obtained time information, and the image data is synthesized with camera image data to output it for broadcasting.

### FIFTH OPERATING EXAMPLE

In the fifth operating example, plug-in data (for example, FLASH animation) is synthesized with camera image.

In this case, when an operating button 67 corresponding to the desired plug-in data is clicked, the plug-in data is synthesized with camera image data to output it for broadcasting.

### SIXTH OPERATING EXAMPLE

In the sixth operating example, a description will be made of the case where sprite process is applied to image data and static image data 34 from camera 21.

The sprite process is a process wherein for example, specific color of static image data 34 is converted into transparent color, and the static image data 34 and image data from camera 21 are superposed and synthesized so that display priority of the static image data 34 is to be upper level.

In this case, for example, as shown in FIG. 8, process prior to plural camera image synthesizing process (Step S2) is different from the case shown in FIG. 4.

That is, image data from camera 21 received in a capture window 41 are applied to a third switching control process (Step S21).

In the third switching control process, for example, any one of image data, and the other image data are selected for storage to the first picture buffer 42, and sprite process (Step S23), respectively.

On the other hand, in the fourth switching control process (Step S22), for example, any one o out of a plurality of static image data is selected in order to apply to the sprite process.

In the sprite process (Step S23), for example, the sprite process is applied to image data from any one of camera 1, and static image data 34. Image data after synthesizing of image data (image data from camera 21) after sprite process and static image data 34 are applied to the plural camera image synthesizing process (Step S2), which is then synthesized with image data from a first picture buffer 42.

In the six operating example, clients are able to audit images based on the image data applied with the sprite process.

### SEVENTH OPERATING EXAMPLE

In the seventh operating example, a description will be made of the case where while receiving live streaming broadcasting from the other streaming server through a network 2, image data f live streaming broadcasting during receiving is output to the network 2 for auditory by clients.

In this case, in the second switching control (Step S6), image data after streaming decoder process by a streaming decoder 46.

As a result, image data of live streaming broadcasting received from the other streaming server 6, or synthesized image data obtained by synthesizing the other image data with the said image data are respectively output (broadcasted) to the network 2.

According to the seventh operating example, clients are able to audit images using image data of the live streaming broadcasting received from the other streaming server 6.

### EIGHTH OPERATING EXAMPLE

In the case of the eighth operating example, as shown in FIG. 9 while receiving live streaming broadcasting from a plurality of other streaming server 6 through a network 2, image data obtained by synthesizing process (streaming data synthesizing process: Step S3) for synthesizing image data of a plurality of live streaming broadcasting during receiving are output to a network 2 for auditory by clients.

It is noted, in the streaming data synthesizing process, for example, alpha blend process or picture-in picture process is carried out.

Further, process (Step S32) for synthesizing the other image data (telop, static image, video image data or the like) may be applied to synthesized image data obtained by the streaming synthesizing process.

Synthesized image data after process of Step S31 or Step S32 are output to the network 2 while applying encoding by a streaming encoder 47.

As described, according to the eighth operating example, since multi-dimensional broadcasting from a plurality of streaming servers 6 are output to the network 2 for auditory, clients are able to audit multi-dimensional broadcasting from a plurality of streaming servers 6.

### Second Embodiment

In the second embodiment, a description will be made of a synchrony-browser function in which link address information of a browser on the broadcaster side t output as a script, and a link address of the browser on the clients side is designated on the basis of the script of the link address information to thereby synchronously switch the link address on the clients side to the broadcaster side.

FIG. 10 is a view showing display on he broadcaster side and the clients side during execution of the synchro-browser function.

As shown in FIG. 10, on a display screen G2 of a display portion 12 of an editing device 1 on the broadcaster side are displayed a browser 91, a mouse pointer 92 within the browser 91, and a display region 93 for carrying out (that is, display of image to be broadcasted) on the basis of image data produced by any of editing process described in the first embodiment.

On the other hand, on a display screen G3 of a terminal for auditory 4 on the clients side are displayed a browser 95, a pointer 96 within the browser 95, and a display region 97 for carrying out image display on the basis of image data broadcasted, It is noted that display data of the pointer 96 is downloaded, at the time of getting access to a server 5 for a home page of the broadcaster, is stored and held in the terminal for auditory 4 till the browser 95 is terminated, and is used for displaying the pointer 96.

Next, it is supposed that operation for switching a link address of the browser 91 is carried out on the broadcaster side. Then, the editing device 1 converts address information of the browser, that is URL (Uniform Resource Locator) to script to output it.

Then, the terminal for auditory 4 receives script from the editing device 1 through a network 2 and a streaming server 3, and converts display of the browser 95 to a link address designated by the script.

Further, in the second embodiment, position information of a mouse pointer (pointer) 92 displayed on a browser on the broadcaster side is output as script, and a display position of a pointer 96 on a browser 95 on the auditory side is designated on the basis of the script of the position information to thereby associate the display position of the pointer 96 on the clients side with the pointer 92 on the broadcaster side (synchro-pointer function).

That is, the editing device 1 converts position information (coordinate position on the browser 91) to script every time when a position of the pointer 92 moves on the broadcaster side to output it.

Then, the terminal for auditory 4 receives the script from the editing device 1 through the network 2 and the streaming server 3, and converts the display position of the pointer 96 to the position designated by the script (coordinate position on the browser 95).

Next, these syncro-browser function and synchro-pointer function will be described with reference to a flowchart of FIG. 11. It is noted one shown in FIG. 11 is process for which a control portion 11 of the editing device 1 is carried out.

As shown in FIG. 11, first, judgment is made whether the synchro-browser function is started by operation of the broadcaster (Step S41).

In the case where the function is started (YES in Step S41), the coordinate of the mouse pointer 92 is converted to the script to perform process for output (Step S42, and then link address information of the browser 91 is converted to the script for output it (Step S43).

In the succeeding step S44, judgment is made whether the synchro-browser function is terminated by operation of the broadcaster.

In the case where the function is not finished (NO in Step S4), the step moves to Step S45.

In Step Se45, judgment is made whether the coordinate of a mouse pointer 92 is changed, and in the case of judgment in which the coordinate is changed (ES in Step S45), process for converting the coordinate of the mouse pointer 92 to the script to output it is carried out (Step S46), and the step moves to Step S47. On the other hand, in Step S45, in the case of judgment in which the coordinate of the mouse pointer 92 is not changed (NO in Step S45), Step S46 is skipped, and the step moves to Step S47.

Further, In Step S47, judgment is made whether link address (link address information) is changed, and in the case of judgment in which the link address is changed (YES in Step 47), process for converting link address information of the browser 91 to the script to output it (Step S45), and the step moves to Step S44 again. On the other hand, in Step S4, in the case of judgment in which the link address is not changed (NO in Step S47), Step S48 is skipped, and the step moves to Step S44.

Further, in the case where judgment is made in which the synchro-browser is finished I Step S44, and in the case where judgment is made in which the synchro-browser function is not started in Step S41, the process in FIG. 11 is finished.

According to the second embodiment as described above, since the synchro-browser function and synchro-pointer function as described above can be realized, for example, presentation, conference or lecture can be suitably carried out through the network. At that time, the broadcaster may merely talk while touching the browser 91 by the mouse to carry out presentation, conference or lecture in a simple manner.

Data of small capacity (script of link address information) may merely be output for switching display of browser 95 n the clients side, and therefore, data capacity handled in the editing device 1 on the broadcaster side can be suppressed as small as possible, and broadcasting contents excellent in expression can be obtained with less process data amount.

In addition, any of broadcasting described in the first embodiment is carried out along with the synchro-browser function and synchro-pointer function as described above, and therefore, the broadcasting contents can be displayed in a display region 97 to enable obtaining broadcasting further excellent in expression. For example, in the display region 97, a presenter or a program director for conference or lecture is displayed to thereby more easily understand presentation, conference or lecture.

### Third Embodiment

In the third embodiment, a description will be made of an example (hand-written function) in which as shown in FIG. 12, image data of images depicted by operation during broadcasting on a browser 91 on the broadcaster side are output to a network 2 for auditory by clients.

In this case, as shown in FIG. 12, the broadcaster operates an operating portion, for example, such as a mouse 14b during broadcasting to provide a depicted image on a browser 91, whereby its depicted image is reflected so that the image data is synthesized with, for example, animation data (camera image data from camera 21, video image data from a video decoder 45, or image data of other streaming broadcasting from a streaming decoder 46) to output it to a network 2.

As a result, image depicted by operation of the broadcaster is also reflected by display on a browser 495 of the auditory terminal 4 on the clients side.

Next, a flow of process in the case of the third embodiment will be described with reference to FIG. 13.

Animation data 98a is, as described above, for example, camera image data from camera 21, video image data from a video decoder 45, or image data of other live streaming broadcasting from a streaming decoder 46. Further, image data 98b is image data of an image layer in which depicted image by the broadcaster is reflected on display. These image data 98b and animation data 98a are synthesized by synthesizing process 99. As a result, image data after synthesizing is data for displaying to which depicted image depicted by the broadcaster is superposed.

Such image data after synthesizing is stored in a main picture buffer 44, after which it is encoded for streaming broadcasting by a streaming encoder 47 and output to a network.

The terminal for auditory 4 for receiving image data output as described is able to audit broadcasting contents in which depicted image by the broadcaster is reflected.

According to the third embodiment as described, the broadcaster performs depicted image in a simple manner at real time to enable causing image display on the basis of image data of the depicted image to carry out by the terminal for auditory 4. Thereby, presentation can be carried out easily through the network 2.

In the above-described embodiments, a description has been made on assumption of streaming broadcasting, but for example, the technique for outputting image data including plug-in data for broadcasting may be applied, not limiting to the live streaming broadcasting, to other broadcasting methods.

1-39. (canceled)

40. A live streaming broadcasting method for broadcasting through a network, said method comprising the steps of inputting a plurality of camera image data and synthesizing said plurality of camera image data via a synthesizing process, and simultaneously outputting synthesized image data of said plurality camera image data through said network for auditing by clients.

41. A live streaming broadcasting method for broadcasting through a network, said method comprising the steps of receiving one live streaming broadcasting image data through a network, and synthesizing said one live streaming broadcasting image data and other live streaming broadcasting image data by a synthesizing process, synthesized image data of said live streaming broadcasting image data are output through said network for auditing by clients.

42. The live streaming broadcasting method according to claim 40, wherein said image data includes at least any one of static image data and video image data.

43. The live streaming broadcasting method according to claim 41, wherein said image data includes at least any one of static image data and video image data.

44. The live streaming broadcasting method according to claim 40, wherein said image data includes text display data input by an operation during broadcasting.

45. The live streaming broadcasting method according to claim 41, wherein said image data includes text display data input by an operation during broadcasting.

46. The live streaming broadcasting method according to claims 40, wherein said image data including designated information for an image display designation.

47. The live streaming broadcasting method according to claims 41, wherein said image data including designated information for an image display designation.

48. The live streaming broadcasting method according to claim 40, wherein said image data includes a plug-in data.

49. The live streaming broadcasting method according to claim 41, wherein said image data includes a plug-in data.

50. The live streaming broadcasting method according to claim 40, wherein said synthesizing process is alpha blend process or picture-in picture process.

51. The live streaming broadcasting method according to claim 41, wherein said synthesizing process is an alpha blend process or picture-in picture process.

52. A live streaming broadcasting method for live broadcasting through a network wherein link address information of a browser on the broadcaster side is output as a script, and a link address of a browser on the clients side on the basis of the script of said link address information to thereby synchronously switch the link address on the clients side to the broadcaster side.

53. A live streaming broadcasting method for live broadcasting through a network wherein position information of a pointer displayed on a browser on the broadcaster side is output as a script, and a display position of a pointer on the browser on the clients side is designated on the basis of the script of said position information to thereby associate the display position of the pointer on the clients side with the broadcaster side.

54. A live streaming broadcasting apparatus for broadcasting a live streaming image data through a network, comprising:
receiving means for receiving one live streaming image data through said network; and
outputting means for outputting said live streaming image data to said network for auditory by clients during receiving said image data.

55. The live streaming broadcasting apparatus according to claim 54, wherein said outputting means outputs text display data input by an operation during broadcasting to said network for auditory by clients.

56. The live streaming broadcasting apparatus according to claim 54, wherein said outputting means outputs image data including designated information for an image display designation.

57. The live streaming broadcasting apparatus according to claim 54, wherein said outputting means outputs plug-in data to said network for auditory by clients.

58. A live streaming broadcasting apparatus for broadcasting a live streaming image data through a network, said method comprising the steps of executing a process for outputting link address information of a browser on the broadcaster side as a script, and designating a link address of the browser on the clients side on the basis of the script of said link address information to thereby synchronously switch the link address on the clients side to the broadcaster side.

59. A live streaming broadcasting apparatus for broadcasting a live streaming image data through a network wherein position information of a pointer displayed on a browser on the broadcaster side is output as a script, and a display position of the pointer on the browser on the clients side is designated on the basis of the script of said position information to thereby associate the display position of the pointer on the clients side with the broadcaster side.

60. A live streaming broadcasting apparatus for broadcasting a live streaming image data through a network, comprising outputting means for outputting image data of image depicted by operation of the broadcaster on the browser on the broadcaster side to said network for auditory by clients.

61. The live streaming broadcasting apparatus according to claim 60, said outputting means includes synthesizing means for synthesizing said image data of image depicted by operation of the broadcaster with animation image data, said output means outputting image data after synthesizing by said synthesizing means to said network.

62. A computer program for synthesizing a plural camera image data input in an computer to produce synthesized image data, comprising the following processes:
switching process for selecting camera image data for applying a suitable plurality of camera image data out of three or more camera image data input in said apparatus to said plurality camera image synthesizing process selectively;
synthesizing process said plural camera image data in order to be executed by said computer; and
outputting process for outputting synthesized image data of said plural camera image.

63. The computer program according to claim 62, wherein said synthesizing process is alpha blend process or picture-in picture process.
